(19) United States
(12) Patent Application Publication
(10) Pub. No.: US 2003/0118225 A1
(43) Pub. Date: Jun. 26, 2003

(54) IMAGE PROCESSING APPARATUS INCLUDING FIRST AND SECOND IMAGE MANIPULATION UNITS AND ADDITION UNIT IMAGE TAKING PROCESSING SYSTEM INCLUDING IMAGE TAKING APPARATUS AND IMAGE PROCESSING APPARATUS IMAGE PROCESSING FIRST AND SECOND IMAGE MANIPULATION STEPS AND ADDITION STEP AND MEMORY MEDIUM STORING PROGRAM THAT EXECUTES IMAGE PROCESSING METHOD

(76) Inventor: TSUKASA SAKO, UTSUNOMIYA-SHI (JP)

Correspondence Address: FITZPATRICK CELLA HARPER & SCINTO, 30 ROCKEFELLER PLAZA, NEW YORK, NY, 10112, US

(21) Appl. No.: 09/407,084

(22) Filed: Sep. 28, 1999

(30) Foreign Application Priority Data
Sep. 30, 1998 (JP) 10-291385

(51) Int. Cl. G06K 9/00; G06K 9/36; G09G 5/34

(52) U.S. Cl. 382/132; 382/276

(57) ABSTRACT

There are provided an image processing apparatus, an image taking processing system, an image processing method and memory medium which are capable of readily supposing how an object has been photographed with respect to a sensor surface, and more ensuring the operator's memory as to how PA or AP photographing has been conducted. The apparatus includes a display image rotation and mirror part for rotating or mirroring an image for display on the basis of a designation from a designation part, an overlay part for displaying the image for display which has been rotated or mirrored in a rectangular overlay manner, an irradiation area arrangement computation part for computing the arrangement coordinates of an X-ray irradiation field area on the basis of an output size, a cutting-out part for trimming the taken image, a sensor reference marking part for adding sensor reference information onto the image, a rotation and mirror part for rotating or mirroring the image which has been subjected to a marking processing, and an output part for compressing and outputting the image which has been rotated or mirrored.

### BACKGROUND OF THE INVENTION

1. Field of the Invention

The present invention relates to an image processing apparatus, an image taking processing system, an image processing method and a memory medium, and more particularly to an image processing apparatus, an image taking processing system, an image processing method and a memory medium, which are suitable for a case in which it is necessary to know how an object to be photographed is arranged for taking an image when images are collected by a plane sensor and subjected to an image processing, and thereafter the image is trimmed and subjected to mirror and rotation processings to output the image.

2. Related Background Art

In X-ray photographing for the purpose of a medical examination, X-ray photographing using a film screen system in which an intensifying screen and an X-ray photographic film are combined together are frequently conducted. According to this method, X-rays which have penetrated through an object to be photographed include information on the interior of the object to be photographed, which is converted by the intensifying screen into a visible radiation proportional to the intensity of X-rays. The X-ray photographic film is exposed to the visible radiation, and an X-ray image is formed on the film.

In general, in the X-ray photographing, when a case in which an operator photographs an object in a PA (toward a front face from a back face) manner and a case in which he photographs the object in an AP (toward the back face from the front face) manner are outputted to a film, because the film can be observed from both sides thereof, it cannot be understood that in which manner the object has been originally photographed. Specifically, although a medical doctor observes the film in a state where a heart is positioned on the right in the case of the film of a breast part, it cannot be understood whether the image has been taken from a front side or from a back side.

Under the above circumstances, conventionally, a character called “lead character” is located in a certain region on the film surface so that it can be understood from which side the image has been taken. However, even applying this method, the arrangement of the lead character in error causes the relation of the front and back sides of a patient to be unclear.

In recent years, an X-ray digital image-taking apparatus starts to be used in which the X-rays are converted by a phosphor into a visible radiation proportional to the intensity of X-rays, then converted by a photo-electric conversion element into an electric signal and then converted by an A/D convertor into a digital signal. Similarly, in this image-taking apparatus, a lead character can be arranged on a sensor surface.

However, the above-described related art suffers from the following problems. That is, there arises such a problem that an error occurs in the arrangement of the lead character on the sensor surface, the error cannot be found from a final output image as in the conventional film screen system.

### SUMMARY OF THE INVENTION

The present invention has been made in view of the above problem, and therefore has an object of the present invention to provide an image processing apparatus, an image taking processing system, an image processing method and a memory medium, with which being capable of easily supposing how an object to be photographed has been photographed with respect to a sensor surface and being capable of more ensuring the operator's memory as to how PA and AP photographing have been conducted.

In order to achieve the above object, according to one aspect of the present invention, there is provided an image processing apparatus that subjects an output image from an image taking means to an image processing, the apparatus comprising: a first image rotation and mirror means for rotating or mirroring an image on the basis of an external input when the image is taken; an addition means for recording within the image a mark for discriminating how the image is read out from the image taking means; and a second image rotation and mirror means for rotating or mirroring the image processed by the addition means on the basis of the external input.

### BRIEF DESCRIPTION OF THE DRAWINGS

FIG. 1 is a block diagram showing the structure of a control system for an irradiation field area arrangement and a sensor reference marking processing in accordance with an embodiment of the present invention;

FIG. 2 is a block diagram showing the structure of a system consisting of an X-ray image forming device and an X-ray image reading device in accordance with the embodiment of the present invention;

FIG. 3 is an explanatory diagram showing the display of an irradiation field area and a film area in accordance with the embodiment of the present invention;

FIG. 4 is an explanatory diagram showing a table representative of the corresponding relationship of a pre-designated size, an arrangement category and the number of pixels in accordance with the embodiment of the present invention;

FIG. 5 is an explanatory diagram showing a scale-down processing of irradiation field in accordance with the embodiment of the present invention;

FIG. 6 is an explanatory diagram showing a partially trimming processing of irradiation field in accordance with the embodiment of the present invention;

FIG. 7 is an explanatory diagram showing a processing designated by an operator in accordance with the embodiment of the present invention;

FIG. 8 is an explanatory diagram showing a sensor reference mark in accordance with the embodiment of the present invention;

FIG. 9 is an explanatory diagram showing a scale-down mark in accordance with the embodiment of the present invention;

FIG. 10 is a flowchart showing an irradiation area arrangement computation processing in accordance with the embodiment of the present invention;

FIG. 11 is a flowchart showing an irradiation area arrangement computation processing in accordance with the embodiment of the present invention; and

FIG. 12 is an explanatory diagram showing an out-framed margin computation in accordance with the embodiment of the present invention.

### DESCRIPTION OF THE PREFERRED EMBODIMENTS

Hereinafter, a description will be given in more detail of an embodiment of the present invention with reference to the accompanying drawings.

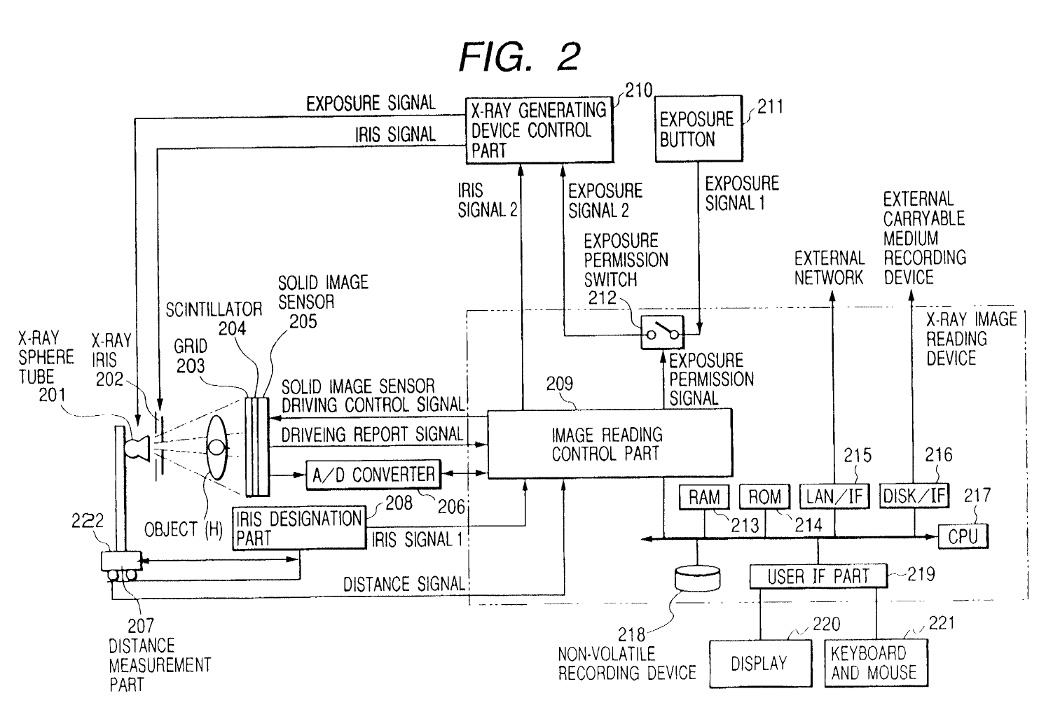

FIG. 2 is a block diagram showing constituents of a system consisting of an X-ray image forming device and an X-ray image reading device in accordance with the embodiment of the present invention. The system consisting of the X-ray image forming device and the X-ray image reading device in accordance with the embodiment of the present invention includes an X-ray sphere tube 201, an X-ray iris 202, a grid 203, a scintillator 204, a solid image sensor 205, an A/D converter 206, a distance measurement part 207, an iris designation part 208, an image reading control part 209, an X-ray generating device control part 210, and an exposure button 211. Also, the system includes an exposure permission switch 212, a RAM 213, a ROM 214, a LAN (local area network)/IF (interface) 215, a DISK/IF 216, a CPU 217, a non-volatile recording device 218, a user IF part 219, a display 220, and a keyboard and mouse 221. In the figure, “H” denotes an object to be photographed, and an area surrounded by an alternate long and two short dashes line denotes the X-ray image reading device.

The structure of the above respective parts will be described in more detail. The X-ray sphere tube 201 is so designed as to irradiate X-rays onto the object H on the basis of the control by the X-ray generating device control part 210. The X-ray sphere tube 201 is fixed to a mobile mechanism 222 and structured so as to be movable through the mobile mechanism 222 so that a distance between the X-ray sphere tube 201 and the solid image sensor 205 can be adjusted. The X-ray iris 202 is, for example, rectangular in configuration and can adjust the amount of opening/closing in a vertical direction and the amount of opening/closing in a horizontal direction, respectively. The irradiation of the X-rays onto the image-taken part of the object H through X-ray iris 202 can be appropriately adjusted by using a lamp light. The transmitted rays of X-rays that have passed through the object H are inputted as an image to the solid image sensor 205 through the grid 203 and scintillator 204.

The solid image sensor 205 is so designed as to convert the transmitted rays of X-rays into an electric signal and outputs a driving report signal to the image reading control part 209, and the image reading control part 209 outputs the electric signal to the A/D converter 206. The A/D converter 206 converts the electric signal outputted from the solid image sensor 205 into a digital signal. The distance measurement part 207 is adapted to measure a distance between the X-ray sphere tube 201 and the solid image sensor 205 and outputs a distance signal to the image reading control part 209. The iris designation part 208 is used to adjust the amount of iris of the X-ray iris 202 by the operator and outputs an iris signal 1 based on the adjustment of the amount of iris to the image reading control part 209.

The X-ray generating device control part 210 is designed to control the X-ray generating device including the X-ray sphere tube 201, outputs an exposure signal 3 to the X-ray sphere tube 201 on the basis of an exposure signal 2 from the exposure permission switch 212 and outputs the iris signal 3 to the X-ray iris 202 on the basis of the iris signal 2 from the image reading control part 209. The exposure button 211 functions as a trigger that generates X-rays and outputs an exposure signal 1 to the exposure permission switch 212.

The image reading control part 209 is managed by the CPU 217, outputs a solid image sensor driving control signal to the solid image sensor 205, outputs the iris signal 2 to the X-ray generating device control part 210 and outputs the exposure permission signal to the exposure permission switch 212. The exposure permission switch 212 turns on on the basis of the exposure permission signal from the image reading control part 209 to output the exposure signal 1 from the exposure button 211 as the exposurg signal 2. The RAM 213 is made up of a writable and readable memory and temporarily stores image data therein. The ROM 214 is made up of a read-only memory and stores a control program and fixed data therein. The LAN/IF 215 conducts interface with respect to an external network (not shown).

The DISK/IF 216 conducts interface when data is transmitted or received with respect to an external portable memory recording device (not shown). The CPU 217 is a central processing unit and manages the image reading control part 209. The CPU 217 is connected to the image reading control part 209 as well as the RAM 213, the ROM 214, the LAN/IF 215, the DISK/IF 216, a control panel (not shown), the non-volatile recording device 218 and the user IF part 219 through a bus. The non-volatile recording device 218 is made up of, for example, a hard disk, and stores the image data therein. The user IF part 219 is connected to the display 220 and the keyboard and mouse 221 and conducts interface with the user. The display 220 conducts various displays. The keyboard and mouse 221 are used for various inputs.

Subsequently, the system consisting of the X-ray image forming device and the X-ray image reading device in accordance with the embodiment of the present invention will be described. The operator locates the object H to be photographed between the solid image sensor 205 and the X-ray sphere tube 201. Then, a part to be photographed is selected, by use of a user interface (keyboard and mouse 221). Through this operation, the operator designates the arrangement mode of the object H, that is, whether PA (exposure is made from the back side toward the front side) photographing or AP (exposure is made from the front side toward the back side) photographing is conducted. At the same time, the image reading control part 209 applies a voltage to the solid Image sensor 205 lay use of the solid image sensor driving control signal so as to be ready for an image being when, ever inputted to the solid image sensor 205.

Thereafter, the operator moves the X-ray sphere tube 201 through the mobile mechanism 222 with respect to the solid image sensor 205 to an appropriate distance In this situation, the distance between the solid image sensor 205 and the X-ray sphere tube 201 is; inputted to the image reading control part 209 by use of the distance measurement part 207. Then, the operator adjusts the amount of iris of the X-ray iris 202 through the iris designation part 208 so as to enter a part of the object H which the operator intends to photograph. The iris signal 1 is transmitted as the iris signal 2 and the iris signal 3 and used to open or close the X-ray iris 202. The X-ray iris 202 is structured such that the amount of opening or closing both in the vertical direction and in the horizontal direction can be adjusted as described above.

The exposure button 211 functions as a trigger for generating X-rays. The exposure signal 1 generated by the exposure button 211 is once inputted to the image reading control part 209 within the X-ray image reading device. The image reading control part 209 recognizes whether the solid image sensor 205 is in a state where or not it can convert X-rays into an image upon reception of the X-rays, from a state of the driving report signal, and thereafter generates the exposure permission signal. The exposure permission signal allows to turn the exposure permission switch 212 to turn on, thereby producing exposure signal 2 from the exposure signal 1. For the exposure signal, a switch called “second switch” of the exposure button 211 is used.

The exposure signal 2 is transmitted to the X-ray generating device control part 210. The X-ray generating device control part 210 generates the exposure signal 3 as soon as it is ready for X-ray exposure and generates X-rays from the X-ray sphere tube 201. On the other hand, after the solid image sensor 205 has been exposed, the transmitted X-rays are inputted to the solid image sensor 205 through the grid 203 and the scintillator 204 as an image. The image is read out by the solid image sensor 205, then converted into a digital signal by the A/D converter 206 and thereafter transferred to the image reading control part 209. The image which has been transferred to the image reading control part 209 is disposed on the RAM 213 once and then subjected to various processings by the CPU 217 as described later.

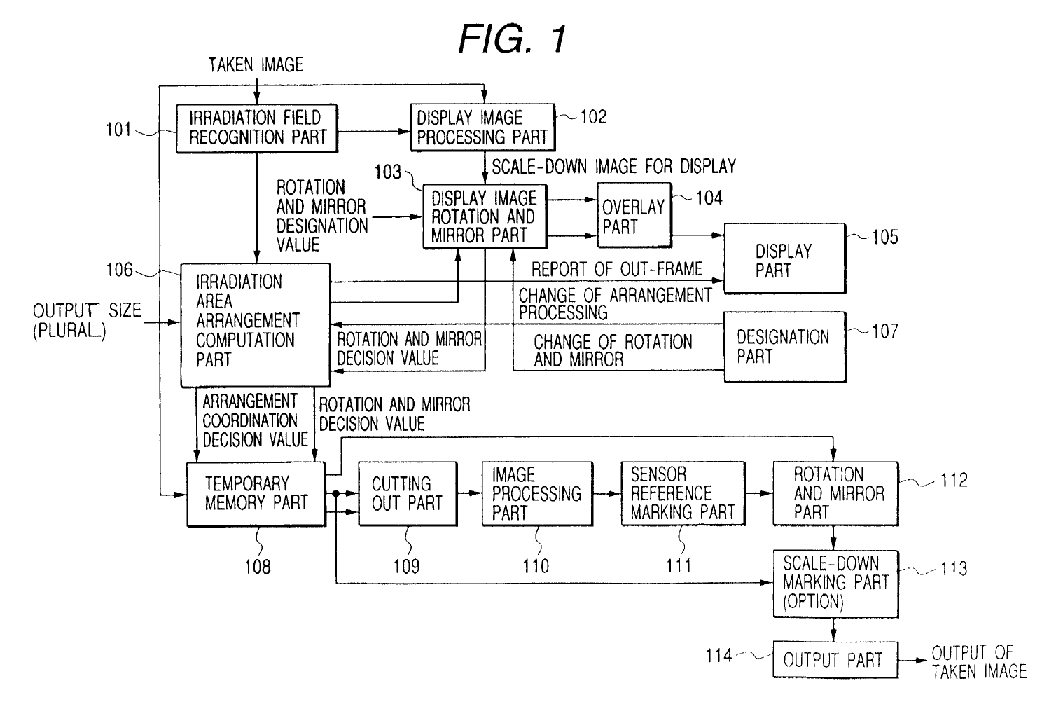

FIG. 1 is a block diagram showing the structure of a control system for an irradiation field area arrangement and a sensor reference marking processing in accordance with a first embodiment of the present invention, and represents the function blocks of the X-ray image reading device shown in FIG. 2. The control system for the irradiation field area arrangement and the sensor reference marking processing in accordance with the first embodiment of the present invention includes an irradiation field recognition part 101, a display image processing part 102, a display image rotation and mirror part 103, an overlay part 104, a display part 105, an irradiation area arrangement computation part 106, a designation part 107, a temporary memory part 108, a cutting out part 109, an image processing part 110, a sensor reference marking part 111, a rotation and mirror part 112, a scale-down marking part 113 and an output part 114.

The function of the above respective parts will be described in more detail. The irradiation field recognition part 101 conducts irradiation field recognition on a taken image. The display image processing part 102 conducts an image processing on the basis of the taken image and the irradiation field area result from the irradiation field recognition part 101 so that contrast within the irradiation field area becomes proper, and generates a scale-down image for display. The display image processing part 102 is inputted with a rotation and mirror designation value. The display image rotation and mirror part 103 conducts the rotation and mirror of the image on the basis of the rotation and mirror designation value designated when the scale-down image for display is photographed. The overlay part 104 conducts rectangular overlay display made by the irradiation field area arrangement coordinates which have been subjected to scale-down, rotation and mirror processings on the scale-down image for display which has been subjected to the rotation and mirror processing.

The display part (display part) 105 displays an image outputted from the overlay part 104. The irradiation area arrangement computation part 106 conducts the arrangement computation on the basis of preset several output sizes. The designation part 107 is used when designating the mirror processing, the rotation processing or the like with respect to the display image rotation and mirror part 103. The temporary memory part 108 temporarily stores therein the taken image as well as an arrangement coordinate decision value and a rotation and mirror decision value which are outputted from the irradiation area arrangement computation part 106. The cutting out part 109 conducts a cutting-out processing (trimming processing) on the taken image on the basis of the arrangement coordinate decision value. The image processing part 110 conducts an image processing on the image data outputted from the cutting out part 109.

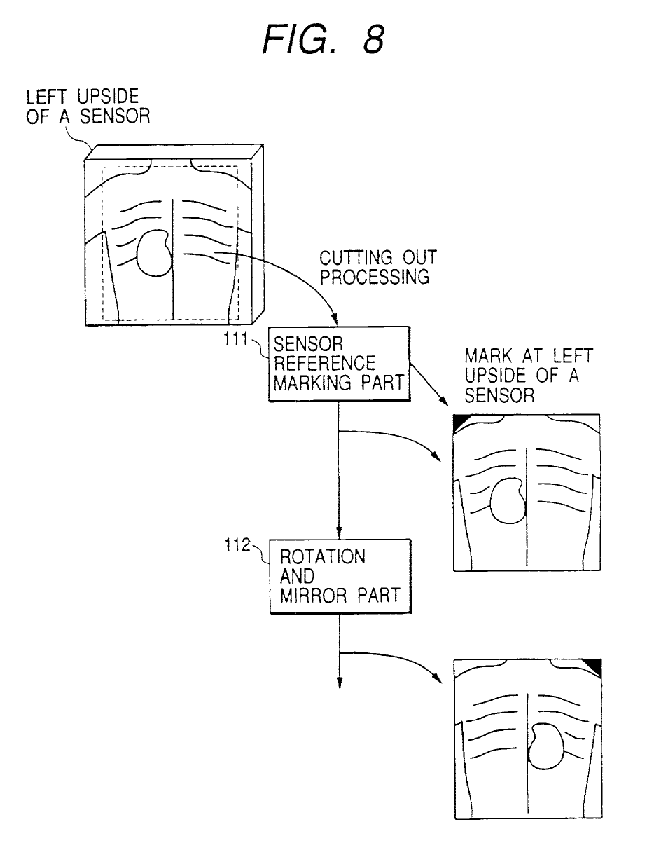

The sensor reference marking part 111 marks a sensor left upside reference on the left upside of the image which indicates the left upside part of the sensor as shown in FIG. 8 after the cutting-out processing is performed by the cutting out part 109. The details of the sensor reference marking processing will be described later. The rotation and mirror part 112 rotates and mirrors the image on the basis of the rotation and mirror decision value. In the case where the scale-down marking part 113 scales down the irradiation field area on a film to a life size or less, marking is made so that it is explicitly found that the film is scaled down. The scale-down marking part 113 is optionally set. The output part 114 outputs an image which has been subjected to a scale-down marking processing.

A description will be given below of the relationship between the respective structural elements as claimed in the claims and the respective parts of the control system for an irradiation field area arrangement and a sensor reference marking processing in accordance with the embodiment of the present invention. A first image rotation and mirror means corresponds to the display image rotation and mirror part 103, a display control means corresponds to the overlay part 104, an irradiation area arrangement computation means corresponds to the irradiation area arrangement computation part 106, a designation means corresponds to the designation part 107, an image cutting-out means corresponds to the cutting-out part 109, an addition means corresponds to the sensor reference marking part 111, a second image rotation and mirror means corresponds to the rotation and mirror part 112, an output means corresponds to the output part 114, an X-ray generating means corresponds to the X-ray sphere tube 201 and the X-ray generating device control part 210, and an image taking means corresponds to the solid image sensor 205.

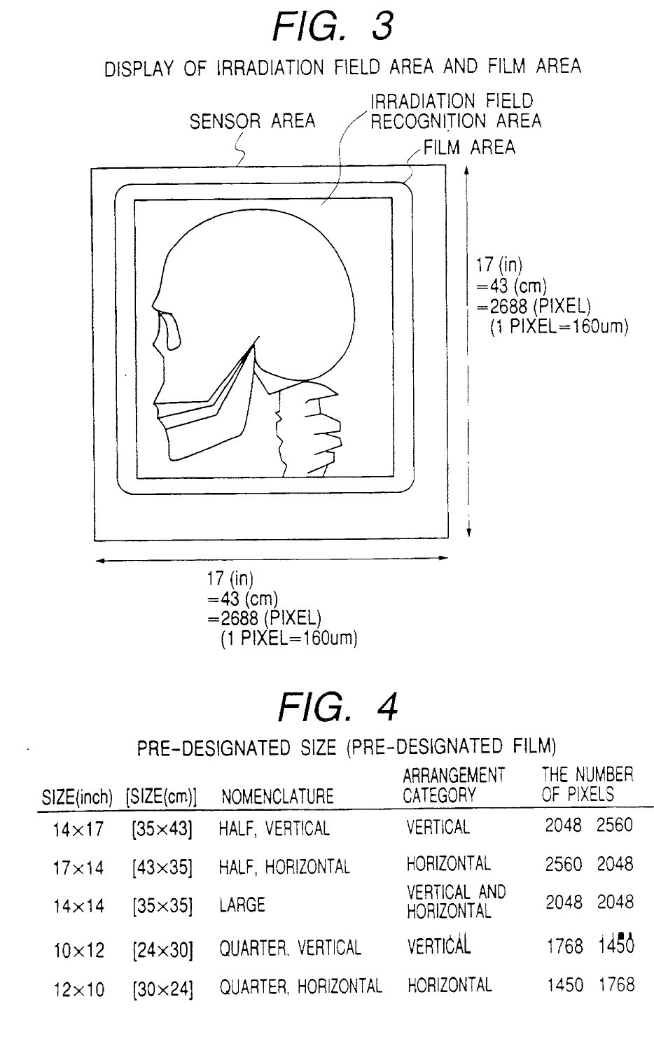

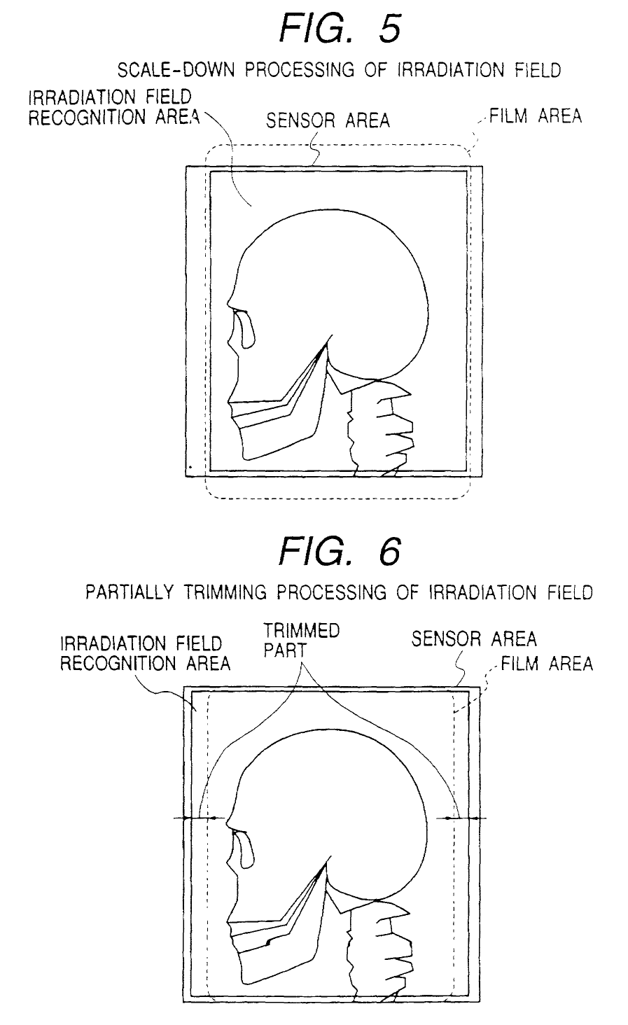

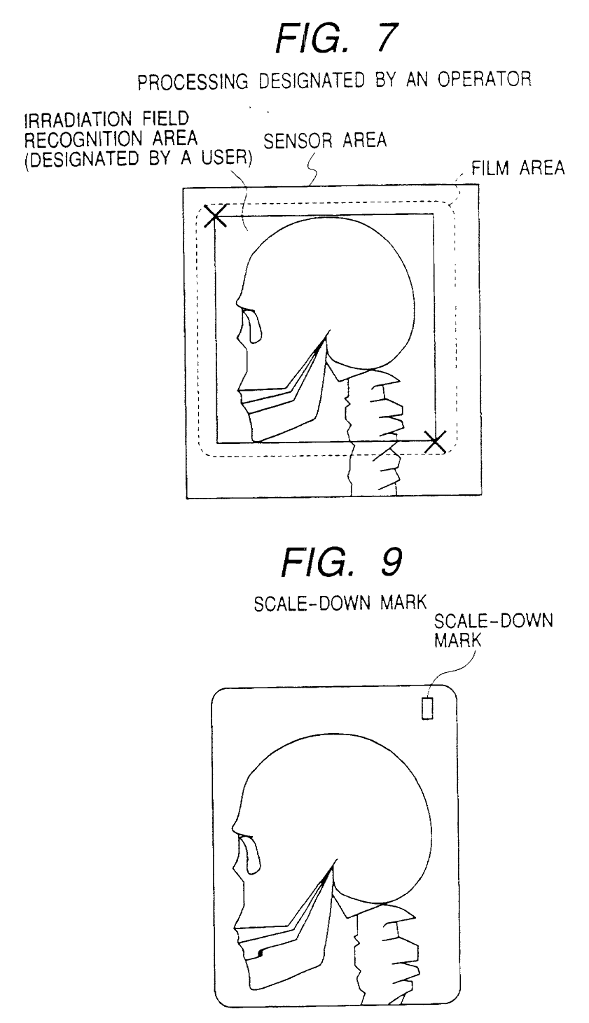

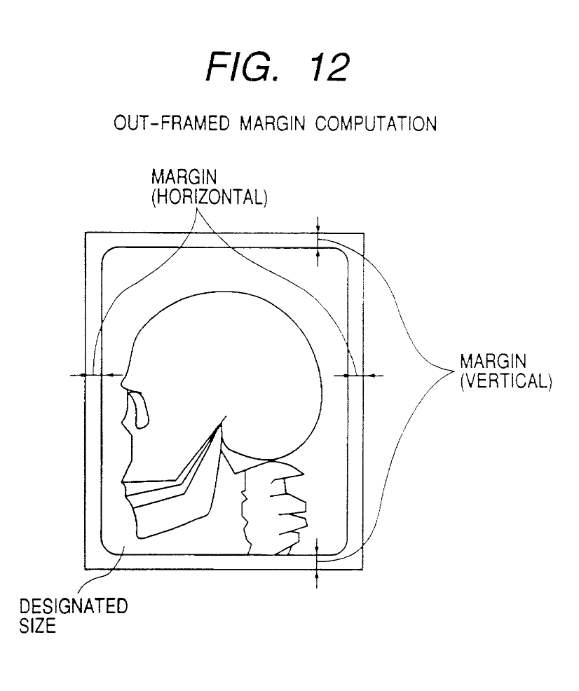

FIG. 3 is an explanatory diagram showing the display of an irradiation field area and a film area. FIG. 4 is an explanatory diagram showing a table representative of a relationship of a pre-designated film size, an arrangement category and the number of pixels. FIG. 5 is an explanatory diagram showing a scale-down processing of irradiation field. FIG. 6 is an explanatory diagram showing a partially trimming processing of irradiation field. FIG. 7 is an explanatory diagram showing a processing designated by an operator. FIG. 8 is an explanatory diagram showing a sensor reference mark. FIG. 9 is an explanatory diagram showing a scale-down mark. FIG. 12 is an explanatory diagram showing an out-framed margin computation.

Subsequently, a description will be given of the operation of the above-described control system for an irradiation field area arrangement and a sensor reference marking processing in accordance with the embodiment of the present invention with reference to FIGS. 1 and 3 to 13.

Referring to FIG. 1, the irradiation field recognition part 101 first conducts irradiation field recognition on the taken image. With this operation, the irradiation field area is computed. There are proposed various irradiation field recognizing methods. Upon recognition of an irradiation field, its result is transmitted to the display image processing part 102. The display image processing part 102 conducts an image processing on the basis of the taken image and the irradiation field area result from the irradiation field recognition part 101 so that contrast within the irradiation field area becomes proper, thereby generating a display scale-down image. However, since this processing is out of the subject matter of this embodiment, its detailed description will be omitted here.

On the other hand, the irradiation field recognition result is transmitted to the irradiation area arrangement computation part 106. The irradiation area arrangement computation part 106 executes arrangement computation on the basis of several predetermined output sizes. The computation algorithm will be described later. As an output in this example, the output sizes are so arranged as to include the irradiation field area of an original taken image.

FIG. 3 shows an example in which the output size includes the irradiation field area. In the example shown in the figure, a large size is arranged in such a manner that the irradiation field area is put in the output size (film area) of the large size (35 cm²).

FIG. 4 shows preset pre-designated sizes. This embodiment has, for example, five different pre-designated sizes, and in an example shown in the figure, a large size is selected. The large size is optimum in that there is a large margin in case of a film size larger than the large size whereas the image cannot be sufficiently put in the output size in case of a film size smaller than the large size.

Returning to FIG. 1, the irradiation area arrangement computation part 106 computes where the pre-designated size is arranged, and its result is transmitted to the display image rotation and mirror part 103. The display image rotation and mirror part 103 conducts the rotation and mirror of the image on the basis of the rotation and mirror designation value which is designated when taking a scale-down image for display.

For example, as shown in FIG. 8, in the case where the operator photographs the object in the PA (a front side from a back side) manner, in this embodiment, for example, a heart is caused to be displayed at the left conversely to a taken image normally viewed by a medical doctor by an influence of a sensor reading direction if the taken image is merely displayed. Accordingly, the mirror processing is required when the image is displayed in the PA photographing. Also, the rotation processing is required for the same reason since an image turns upside down depending on toward which direction a head of a patient is directed with respect to a bed when photographing in lying position photographing and the PA and AP photographing exist even in case of the bed.

The display image rotation and mirror part 103 must conduct the conversion of a coordinate system on the irradiation field area arrangement coordinates taking scale-down ratio for display and the above-described rotation and mirror into consideration. Then, its result is transmitted to the overlay part 104. The overlay part 104 executes a rectangular overlay display using the irradiation field area arrangement coordinates which have been subjected to scale-down, rotation and mirror processing on the image for display which has been subjected to the above-mentioned rotation and mirror processing. Thereafter, display is made on the display part 105.

The irradiation area arrangement computation part 106 notifies the operator that the irradiation field area is out frame of the output size unless the irradiation field area is sufficiently put even in the largest output size. In this embodiment, a warning is issued from the display part 105. In this case, there are following manners which are executed by the operator. In the following description, “life size” implies the same size of image as one of an object. That is, in this case, a life size is the same image size as one of a patient.

(1) An image within the irradiation field area is scaled down so that the irradiation field area is put within the largest output size. In this case, the output image is not of a life size but smaller than the life size. For example, when taking an image, in the case that size of irradiation field is out of size of a film, the image has to be outputted in a scale-down manner in order that the irradiation field is put within the film size. Therefore, in this case, the image is outputted in a film as being smaller than its life size. FIG. 5 shows this example. Although the image in the film area surrounded by a dotted line looks the same size as its life size, the outputted image is smaller than its life size in practice. FIG. 5 is the image artificially scaled up in order to provide a user convenient user interface.

(2) This is the opposite case of the above, item (1). In order to perform a life size output, the image is outputted in an actual size. However, since size of irradiation field is out of size of a film in this case, the area out of the film has to be trimmed to output. FIG. 5 shows this example. An image in the film is the same size as its life size.

(3) The operator designates this area. In this case, when the operator clicks parts indicated by two X marks as shown in FIG. 7 with a mouse, the above-described normal processing is executed provided that those parts are in the irradiation field recognition area. In this example, the large size including this irradiation field recognition area is designated.

Now, a change of the above-mentioned arrangement processing is designated to the designation part 107, in this example, to the irradiation area arrangement computation part 106 by use of the mouse, to thereby achieve the above-described exceptional operation. Similarly, in the rotation and mirror processing, in the case where the operator sets the object to be photographed in the PA (toward the front side from the back side) manner, when an actual direction of the patient is decided, if the patient must be unavoidably photographed in the AP manner according to the symptoms of the patient, the image must be subjected to the mirror processing after photographing. Therefore, the designation part 107 can designate the mirror processing, the rotation processing or the like with respect to the display image rotation and mirror part 103, and upon designation of those processing, the image is again displayed.

Subsequently, in the case where the operator finally accepts the above image arrangement, the arrangement computation is decided. There are two methods of this type. That is, there are one case in which the operator explicitly gives a designation from the designation part 107 and another case in which a time is out without any designation by the operator. In this embodiment, both the methods are implemented, and the time-out period is, for example, 1 minute.

After the decision of the arrangement computation, the taken image, the arrangement coordinate decision value and the rotation and mirror decision value are stored in the temporary memory part 108, in this embodiment, a hard disk. Then, in a background processing, the taken image, the arrangement coordinate decision value and the rotation and mirror decision value are again read out and processed. The reason why the background processing is executed is as follows: That is, in the above description, because processing is conducted on the scaled-down image and logical computation is main, computation is made in a relatively short period of time. The computation of processing which will be described below takes a long period of time because the entire large taken image of 2688×2688 pixels is subjected to an image processing and so on, thereby leading to a problem that the operator cannot proceed to a succeeding photographing during the above processing. If a background processing is conducted, the operator can rapidly advance to a succeeding photographing cycle.

The taken image read out from the hard disk is subjected to a cutting-out processing on the basis of the read arrangement coordinate decision value by the cutting-out part 109. This is a processing of trimming the taken image in accordance with the arrangement coordinate decision value. Then, the taken image is subjected to an appropriate image processing by the image processing part 110 and so adjusted as to produce optimum contrast when diagnosing. Thereafter, the taken image is transmitted to the sensor reference marking part 111. The sensor reference marking part 111 is a remedy for the following case. That is, in the case where the operator sets the object to be photographed in the PA (toward the front side from the back side) and photographs the object, when the actual direction of the patient is decided, the patient must be unavoidably photographed in the AP (toward the back side from the front side) manner according to the symptoms of the patient, and photographing is made in the AP manner. However, the operator forgets the mirror processing.

As shown in FIG. 8, after the cutting-out processing is conducted by the cutting-out part 109, a sensor left upside reference is marked on the left upside of the image which indicates the left upside part of the sensor. Thereafter, even if rotation or mirror is executed, how the image has been taken is found. Since marking is executed after the cutting-out processing, there is no case in which the marking is erased by the cutting-out processing. Also, even if the sensor left upside reference marking information is not actually written onto the image, information representing which corner of the image corresponds to the left upside of the sensor can be added to a header of the image. In this case, in particular, when a final image is transmitted to a printer or a viewer, there is the necessity that those receiver sides read and interprets the header information.

After the sensor reference marking part 111 executes the sensor reference marking as described above, the image is transmitted to the rotation and mirror part 112. The image is rotated and mirrored in accordance with the rotation and mirror decision value stored in the hard disk by the rotation and mirror part 112 and then transmitted to the scale-down marking part 113. The scale-down marking part 113 is so designed as to conduct marking so that when the irradiation field recognition area is scaled down to the life size or smaller on the film which is represented by FIG. 5, this scale-down is explicitly understood. Therefore, this is limited to a case in which the output medium is a printer or a laser image. A large number of laser imagers have a function of printing the output image of the life size or smaller on the laser image side without scaling down the output image in the scale-down processing, and in this embodiment, the scale-down processing is not conducted because the image scale-down relies on the laser image.

The above processing will be described in more detail. The pixel size of the sensor in accordance with this embodiment is 160 microns, and the image which has been cut out into the pixels of 2048×2560 is transmitted with a designation of supplementary scale-up of twice when it is transmitted to a laser image of 80 microns. As a result, the image is supplementally scaled up twice into an image of 4096×5120 pixels by the laser image and outputted. Then, this case makes just a life size. However, if the operator explicitly selects and prints the entire area of the sensor, the image is of 2688×2688 pixels.

In the above printer of 80 microns having 4096×5120 buffer areas, a margin area of the film exists vertically, but the horizontal scale-up ratio is limited with the result of 5120/2688=1.905. Accordingly, the largest scale-up ratio is obtained by the image being supplementally scaled up to about 1.9 times and printed. Therefore, the scale-up of 1.905 times is designated and transferred. This is a scale-up processing from the viewpoint of data. However, since the size is smaller than the life size from the viewpoint of the operator side, it is a life size scale-down processing.

What is shown in FIG. 9 is a scale-down marking. Thereafter, the image is outputted to the external from the output part 114.

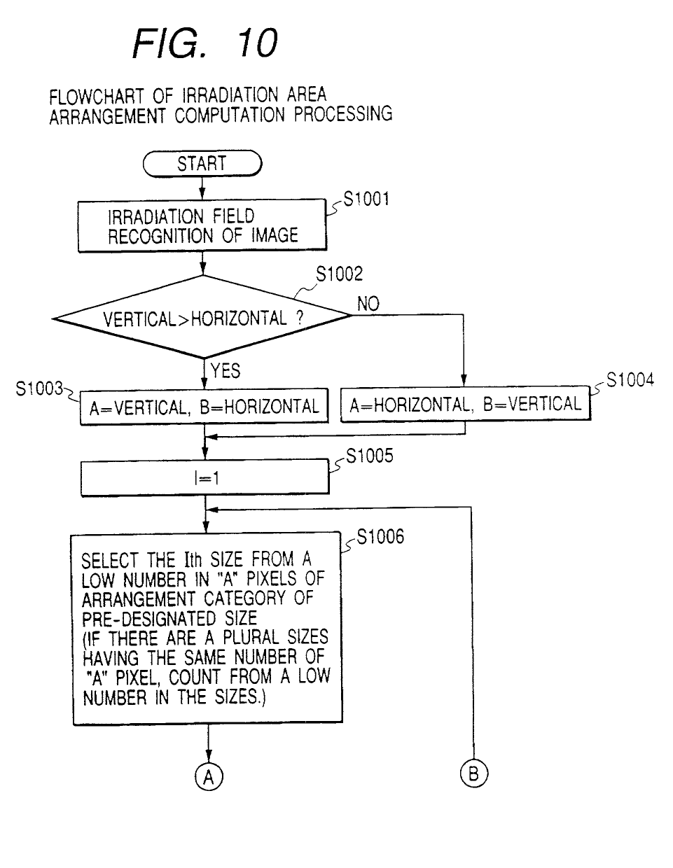

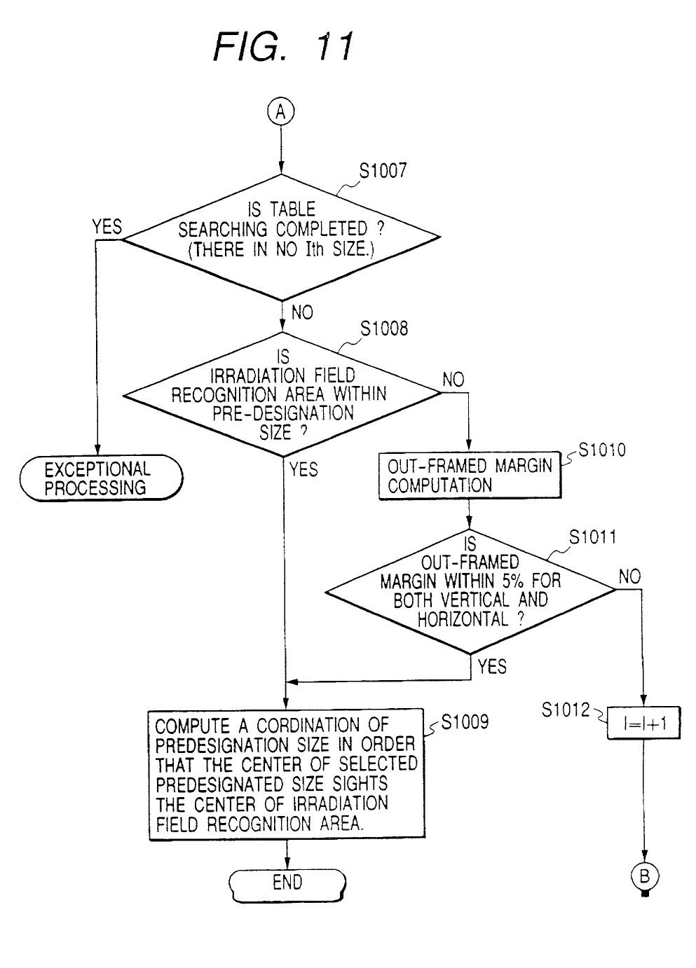

The algorithm of the irradiation area arrangement computation part 106 will be described with reference to FIGS. 10 and 11. FIGS. 10 and 11 are flowcharts showing the irradiation area arrangement computation processing. First, the irradiation field recognition of the taken image is conducted by the irradiation field recognition part 101 (step S1001), and a vertical length and a horizontal length of that area are compared with each other on the basis of the irradiation field recognition result (step S1002). If the vertical length is longer, it is assumed that mark A is the vertical length and mark B is the horizontal length (step S1003). If the horizontal length is longer, it is assumed that the mark A is the horizontal length and the mark B is the vertical length (step S1004). Then, a variable I is initialized to 1 (step S1005). The variable I is used when searching a table in which a pre-designated size is recorded. In this embodiment, the table already shown in FIG. 4 is taken. However, the table can be registered as predetermined initial setting.

Then, the I-th size is selected from a lower number in the pixel of A on the basis of the arrangement category of A in the pre-designated table of FIG. 4. In this situation, if there are plural sizes having the same number of the pixel of A, a lower number in the pixels of B is selected (step S1006). When the table has indexes of the vertical length and the horizontal length, respectively, the size is arranged in the larger order of the respective lengths. Also, when the sizes are identical with each other, the size is arranged in the larger order of the horizontal length when the vertical sizes are identical and in the larger order of the vertical length when the horizontal sizes are identical. The table is searched from the lower toward the upper. For example, in the case where A is vertical, the second size is searched from the smaller one of the vertical length. Since the smallest size is “quarter and vertical”, the second smallest size is “large” or “half and vertical”. However, taking the horizontal pixels into consideration, it is understood that the second smallest size is “large”.

Then, in the case where the table search is completed and the I-th size exists no longer (yes in step S1007), the operation is shifted to an exceptional proceeding. For example, no fourth smallest size exists in the vertical arrangement. There are three different exceptional processings as described with reference to FIG. 1. Then, if the pre-designated size exists, it is judged whether the irradiation field recognition area is within the pre-designated size, or not (step S1008). If the irradiation field recognition area is within the designated size, the coordinates of the pre-designated size are computed so that the center of the selected pre-designated size sights on the center of the irradiation field recognition area (step S1009) and the operation is ended.

On the other hand, if the irradiation field recognition area is not within the pre-designated size, the operation is shifted to an out-framed margin computation (step S1010). The irradiation field recognition pays attention to a fact in which the boundary of the irradiation field is naturally unclear, and even if the circumference of the boundary is somewhat excluded, because the effective area in diagnosis is relatively in the center of the image, the effective area would not be excluded. That is, as shown in FIG. 12, if the respective vertical and horizontal out-framed parts (margin) with respect to the film size are within a given numeral value, respectively, the irradiation field recognition area may be made equivalent to the horizontal or vertical length of the pre-designated size. This is also applied to a case in which only the horizonal length is out-framed or a case in which only the vertical length is out-framed.

That is, in the case where the out-framed part exists, if the out-framed part is 5% of the film length in an out-framed direction (the film length in the vertical direction if vertical whereas the film length in the horizontal direction if horizontal), the irradiation field recognition area is made narrower than the original irradiation field recognition computation so as to be within the pre-designated size. If the out-framed computation result exceeds 5% of the film length, the variable I is increased by 1 (step S1012), and the operation is returned to step S1006 which is subsequent to the above-described initialization of the variable I.

In the above-described embodiment of the present invention, a large number of parts are realized in software for facilitation of implementation and for simplification of the description. However, in case of a higher processing, they are implemented in hardware without giving any influence on the subject matter of the present invention.

As described above, the system consisting the X-ray image forming device and the X-ray image reading device in accordance with the embodiment of the present invention includes the designation part 107 which is capable of designating the rotation and mirror of an image when taking the image, the display image rotation and mirror part 103 that rotates and mirrors the image for display on the basis of the designation by the designation part 107, the overlay part 104 that displays the image rotated and mirrored by the display image rotation and mirror part 103 on a display part 105 in a rectangular overlay manner, the irradiation area arrangement computation part 106 that computes the arrangement coordinates of the X-ray irradiation field area on the basis of a preset output size, the cutting-out part 109 that trims the taken image on the basis of the arrangement coordinate decision value, the image processing part 110 that subjects the image which has been trimmed to an image processing, the sensor reference marking part 111 that records within the image a mark for discriminating how the image is read from the solid image sensor 205, the rotation and mirror part 112 that rotates or mirrors the image which has been subjected to the marking processing on the basis of the rotation and mirror decision value, and the output part 114 that compresses the image which has been rotated or mirrored by the rotation and mirror part 112 and outputs it. With the above structure, the system has the following actions and advantages.

In the above structure, an appropriate part to be outputted from a collected image, that is, a worthy part in diagnosis, for example, an irradiation field area or the like is trimmed by the cutting-out part 109 and then subjected to the appropriate image processing by the image processing part 110. Thereafter, the image is padded with sensor reference information by the sensor reference marking part 111 and subjected to the rotation and mirror processing by the rotation and mirror part 112. Since the image is marked after being trimmed, there is no case in which marking is erased by trimming. As a result, as shown in FIG. 8, if the sensor left upside marking reference on the final output image is searched, it is surely found that the image is taken in a state where a heart is at the left side with respect to the sensor surface. Accordingly, that the original image has been taken in the PA (exposure is made toward the front side from the back side) manner can be discriminated later even if the AP (exposure is made toward the back side from the front side) photographing is made by an operation error.

This is also applied to a lying position photographing, that is, a case where the complicated positions of a patient are combined together such that at which side a head of the patient is put with respect to the bed, the head is upward or downward, and so on. Similarly, in this case, the left upside marking reference of the sensor is searched. This is enabled only when an asymmetric structural substance exists within the image, and attention must be paid to the fact that, for example, a perfect spherical body or the like cannot be judged through the above method. However, there are no problems as to the discrimination of the photographing states (how the PA or AP photographing is conducted) of the respective parts of a human (a person to be detected).

Therefore, even in the case where a lead character is stuck onto a film surface in error, since a mark recorded within the image or information added to the image header, that is, the sensor (solid image sensor 205) reference information is searched, it can be readily supposed how the object has been photographed with respect to the sensor surface, and the operator's memory as to how the PA (exposure is made from the back side toward the front side) photographing or the AP (exposure is made from the front side toward the back side) photographing has been conducted can be more ensured. It is difficult to obtain this advantage by the conventional lead character.

Also, because the marking processing in which the mark is recorded within the image or information is added to the image header is executed after completion of the image cutting-out processing, there is no case in which marking is erased by the image cutting-out processing.

The present invention may be applied to a system made up of a plurality of equipments or applied to a device made up of one equipment. It is needless to say that the present invention is achieved even if the memory medium that stores a program code of software which realizes the functions of the above-described embodiment therein is supplied to a system or a device, and a computer (or a CPU or MPU) in the system or the device reads and executes the program code stored in the memory medium.

In this case, the program code per se read out from the memory medium realizes the functions of the above-described embodiment, and the memory medium that stores the program code therein becomes a structural element of the present invention.

The memory medium for supplying the program code may be, for example, a floppy disk, a hard disk, an optical disk, a photo-magnetic disk, a CD-ROM, a CD-R, a magnetic tape, a non-volatile memory card, a ROM or the like.

Also, it is needless to say that the execution of the program code read out by the computer allows not only the functions of the above-described embodiment to be realized, but also an OS or the like which is running on the computer to conduct a part or all of the actual processing so that the functions of the above-described embodiment are realized by that processing.

In addition, it is needless to say that the present invention is also applied to a case in which after the program code read out from the memory medium is written in a memory provided in a function expansion board which is inserted into the computer or a function expansion unit connected to the computer, the CPU or the like provided in the function expansion board or the function expansion unit conducts a part or all of the actual processing on the basis of the designation of the program code, and the functions of the above-mentioned embodiment are realized by that processing.

As described above, according to the image processing apparatus of the present invention, a mark for discriminating how the image has been read out from the image taking means is recorded within the image, or information indicating how the image has been taken is added to the image header. Hence, even in the case where a lead character is stuck onto a film surface in error, since a mark recorded within the image or information added to the image header, that is, the image taking means (sensor) reference information is searched, it can be readily supposed how the object has been photographed with respect to the image taking means (sensor) surface, and the operator's memory as to how the PA (exposure is made from the back side toward the front side) photographing or the AP (exposure is made from the front side toward the back side) photographing has been conducted can be more ensured. It is difficult to obtain this advantage by the conventional lead character.

Also according to the image processing apparatus of the present invention, because the marking processing in which the mark is recorded within the image is executed after completion of the image cutting-out (trimming) processing, there is obtained such an advantage that marking is not erased by the image cutting-out processing, in addition to the same advantages as those in claims 1 to 5 and 7 to 11.

Further, according to the image taking processing system of the present invention, in the image processing apparatus that constitutes the system, a mark for discriminating how the image has been read out from the image taking means of the image taking apparatus that constitutes the system is recorded within the image, or information indicating how the image has been taken is added to the image header. Hence, even in the case where a lead character is stuck onto a film surface in error, since a mark recorded within the image or information added to the image header, that is, the image taking means (sensor) reference information is searched, it can be readily supposed how the object has been photographed with respect to the image taking means (sensor) surface, and the operator's memory as to how the PA (exposure is made from the back side toward the front side) photographing or the AP (exposure is made from the front side toward the back side) photographing has been conducted can be more ensured. It is difficult to obtain this advantage by the conventional lead character.

Still further, according to the image processing method of the present invention, in the image processing apparatus to which an image processing method is applied, a mark for discriminating how the image has been read out from the image taking means is recorded within the image, or information indicating how the image has been taken is added to the image header. Hence, even in the case where a lead character is stuck onto a film surface in error, since a mark recorded within the image or information added to the image header, that is, the image taking means (sensor) reference information is searched, it can be readily supposed how the object has been photographed with respect to the image taking means (sensor) surface, and the operator's memory as to how the PA (exposure is made from the back side toward the front side) photographing or the AP (exposure is made from the front side toward the back side) photographing has been conducted can be more ensured. It is difficult to obtain this advantage by the conventional lead character.

Yet still further, according to the image processing method of the present invention, in the image processing apparatus to which the image processing method is applied, because the marking processing in which the mark is recorded within the image is executed after completion of the image cutting-out (trimming) processing, there is obtained such an advantage that marking is not erased by the image cutting-out processing.

Yet still further, according to the memory medium of the present invention, the image processing method is read out from the memory medium and executed, and a mark for discriminating how the image has been read out from the image taking means is recorded within the image, or information indicating how the image has been taken is added to the image header. Hence, even in the case where a lead character is stuck onto a film surface in error, since a mark recorded within the image or information added to the image header, that is, the image taking means (sensor) reference information is searched, it can be readily supposed how the object has been photographed with respect to the image taking means (sensor) surface, and the operator's memory as to how the PA (exposure is made from the back side toward the front side) photographing or the AP (exposure is made from the front side toward the back side) photographing has been conducted can be more ensured. It is difficult to obtain this advantage by the conventional lead character.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An image processing apparatus for conducting an image processing on an output image from image taking means, comprising:
first image rotation and mirror means for rotating or mirroring the image on the basis of an external input when taking the image;
addition means for recording a mark that discriminates how the image is read out from the image taking means within the image; and
second image rotation and mirror means for rotating or mirroring the image processed by the addition means on the basis of an external input.

2. An image processing apparatus according to claim 1, further comprising designation means for designating the rotation or mirror of the image when taking the image;
wherein the first image rotation and mirror means rotates or mirrors an image for display on the basis of a designation from the designation means;
wherein the addition means records a mark within the image, the mark discriminating how the image is read out from the image taking means which is arranged as being opposed to an object; and
wherein said second image rotation and mirror means rotates or mirrors the image processed by the addition means on the basis of designation from the designation means.

3. An image processing apparatus for conducting an image processing on an output image from image taking means, comprising:
first image rotation and mirror means for rotating or mirroring the image on the basis of an external input when taking the image;
addition means for adding information representing how the image is taken to an image header; and
second image rotation and mirror means for rotating or mirroring the image processed by the addition means on the basis of an external input.

4. An image processing apparatus according to claim 3, further comprising designation means for designating the rotation or mirror of the image when taking the image;
wherein the first image rotation and mirror means rotates or mirrors an image for display on the basis of a designation from the designation means;
wherein the addition means adds information representing which portion of the image corresponds to a given portion of the image taking means to the image header; and
wherein the second image rotation and mirror means rotates or mirrors the image processed by said addition means on the basis of the designation from the designation means.

5. An image processing apparatus according to claim 1, further comprising display control means for displaying the image rotated or mirrored by the first image rotation and mirror means.

6. An image processing apparatus according to claim 1, further comprising image cutting-out means for trimming the taken image;
wherein the addition means records said mark after completion of trimming by the image cutting-out means; and
wherein the second image rotation and mirror means rotates or mirrors the image in which the mark is recorded by the addition means.

7. An image processing apparatus according to claim 1, wherein the image processing apparatus conducts an image processing on an image outputted from an image taking device including X-ray generating means for exposing X-rays to an object and said image taking means for taking an image on the basis of X-rays have penetrated through the object.

8. An image processing apparatus according to claim 7, further comprising irradiation area arrangement computation means for computing arrangement coordinates of an X-ray irradiation field area on the basis of a predetermined output size.

9. An image processing apparatus according to claim 8, wherein said image cutting-out means trims the taken image on the basis of the arrangement coordinates computed by the irradiation area arrangement computing means.

10. An image processing apparatus according to claim 1, further comprising output means for compressing and outputting the image rotated or mirrored by the second image rotation and mirror means.

11. An image processing apparatus according to claim 1, wherein the image processing apparatus transmits or receives data with respect to an external network or an external equipment.

12. An image taking processing system having an image taking apparatus and an image processing apparatus for conducting an image processing on an output image from the image taking apparatus,
wherein the image taking apparatus comprises: X-ray generating means for exposing X-rays to an object, and image taking means for taking an image on the basis of X-rays that have penetrated through the object; and
wherein the image processing apparatus comprises: first image rotation and mirror means for rotating or mirroring the image on the basis of an external input when taking the image; addition means for recording a mark that discriminates how the image is read out from the image taking means within the image; and second image rotation and mirror means for rotating or mirroring the image processed by the addition means on the basis of an external input.

13. An image taking processing system having an image taking apparatus and an image processing apparatus for conducting an image processing on an image outputted from the image taking apparatus,
wherein the image taking apparatus comprises X-ray generating means for exposing X-rays to an object and image taking means for taking the image on the basis of X-rays that have penetrated through the object; and
wherein the image processing apparatus comprises: first image rotation and mirror means for rotating or mirroring the image on the basis of an external input when taking the image; addition means for adding information representing how the image is taken to an image header; and second image rotation and mirror means for rotating or mirroring the image processed by the addition means on the basis of an external input.

14. An image processing method which is applied to an image processing apparatus or an image taking processing system for conducting an image processing on an image outputted from image taking means, said method comprising:
a first image rotation and mirror step of rotating or mirroring the image on the basis of an external input when taking the image;
an addition step of recording a mark that discriminates how the image is read out from said image taking means within the image; and
a second image rotation and mirror step of rotating or mirroring the image processed by said addition step on the basis of an external input.

15. An image processing method according to claim 14, further comprising a designation step of designating the rotation or mirror of the image when taking the image;
wherein an image for display is rotated or mirrored in the first image rotation and mirror step on the basis of a designation in said designation step;
wherein a mark is recorded within the image in the addition step, the mark discriminating how the image is read out from said image taking means which is arranged as being opposed to an object; and
wherein said second image rotation and mirror step rotates or mirrors the image processed in said addition step on the basis of the designation in the designation step.

16. An image processing method which is applied to an image processing apparatus or an image taking processing system for conducting an image processing on an image outputted from image taking means, said method comprising:
a first image rotation and mirror step of rotating or mirroring the image on the basis of an external input when taking the image;
an addition step of adding information representing how the image is taken to an image header; and
a second image rotation and mirror step of rotating or mirroring the image processed in the addition step on the basis of an external input.

17. An image processing method according to claim 16, further comprising a designation step of designating the rotation or mirror of the image when taking the image;
wherein the first image rotation and mirror step rotates or mirrors an image for display on the basis of a designation in the designation step;
wherein information is added to the image header in the addition step, the information representing which portion of the image corresponds to a given portion of said image taking means; and
wherein the image is rotated or mirrored in the second image rotation and mirror step, the image being processed in the addition step on the basis of the designation in the designation step.

18. An image processing method according to claim 14, further comprising a display control step of displaying the image rotated or mirrored by the first image rotation and mirror step.

19. An image processing method according to claim 14, further comprising an image cutting-out step of trimming the taken image;
wherein the mark is recorded in the addition step after completion of trimming by the image cutting-out step; and
wherein the image in which said mark is recorded in said addition step is rotated or mirrored in the second image rotation and mirror step.

20. An image processing method according to claim 14, wherein said image processing method conducts an image processing on an image outputted from an image taking device including X-ray generating means for exposing X-rays to an object and said image taking means for taking the image on the basis of X-rays that have penetrated through the object.

21. An image processing method according to claim 20, further comprising irradiation area arrangement computation step of computing arrangement coordinates of an X-ray irradiation field area on the basis of a predetermined output size.

22. An image processing method according to claim 21, wherein the taken image is trimmed in the image cutting-out step on the basis of the arrangement coordinates computed by said irradiation area arrangement computing step.

23. An image processing method according to claim 14, further comprising an output step of compressing and outputting the image rotated or mirrored in the second image rotation and mirror step.

24. An image processing method according to claim 14, wherein said image processing method is applicable to an image processing apparatus or an image taking processing system which can transmit or receive data with respect to an external network or an external equipment.

25. A memory medium readable by a computer that stores therein program that executes an image processing method applied to an image processing apparatus or an image taking processing system which conduct an image processing on an output image from image taking means, said medium comprises:
a first image rotation and mirror step of rotating or mirroring the image on the basis of an external input when taking the image;
an addition step of recording a mark that discriminates how the image is read out from said image taking means within the image; and
a second image rotation and mirror step of rotating or mirroring the image processed in the addition step on the basis of an external input.

26. A memory medium readable by a computer that stores therein program that executes an image processing method applied to an image processing apparatus or an image taking processing system which conduct an image processing on an output image from image taking means, said medium comprises:
a first image rotation and mirror step of rotating or mirroring the image on the basis of an external input when taking the image;
an addition step of adding information representing how the image is taken to an image header; and
a second image rotation and mirror step of rotating or mirroring the image processed in the addition step on the basis of an external input.
